(19) United States
(12) Patent Application Publication
(10) Pub. No.: US 2010/0119742 A1
(43) Pub. Date: May 13, 2010

(54) Multilayer, white, biaxially oriented polyester film with metallic-luster outer layer

(76) Inventors: Martin JESBERGER, Mainz (DE); Holger Kliesch, Ginsheim (DE); Bodo Kuhmann, Runkel (DE); Ingo Fischer, Heistenbach (DE)

Correspondence Address: PROPAT, L.L.C., 425-C SOUTH SHARON AMITY ROAD, CHARLOTTE, NC, 28211-2841, US

(21) Appl. No.: 12/614,492

(22) Filed: Nov. 9, 2009

(30) Foreign Application Priority Data
Nov. 12, 2008 (DE) 10 2008 056 870.8

(51) Int. Cl. B32B 1/06; B32B 27/36; B32B 5/16; B32B 27/06; B29C 47/06; B32B 1/02

(52) U.S. Cl. 428/34.8; 428/480; 428/328; 428/220; 264/173.16; 428/35.7

(57) ABSTRACT

The invention relates to a multilayer, white, biaxially oriented polyester film that includes a base layer (B) formed from a thermoplastic polyester plus a whitening pigment, the film further including at least one outer layer (A) formed from thermoplastic polyester. The outer layer (A) also includes, alongside a whitening pigment, a prescribed concentration of a phyllosilicate plus a prescribed concentration of carbon black particles. The invention further relates to a process for the production of the film, and to the use of the film as lid film for pots used for packaging.

### CROSS-REFERENCE TO RELATED APPLICATIONS

This application claims priority to German Patent Application 10 2008 0568 870.8 filed Nov. 12, 2008 which is hereby incorporated herein by reference in its entirety.

### FIELD OF THE INVENTION

The invention relates to a multilayer, biaxially oriented polyester film, white on one side, with metallic-luster outer layer comprising a base layer (B) comprising a thermoplastic polyester and a white pigment, and also at least one outer layer (A). The outer layer (A) also comprises, alongside a white pigment, a certain amount, with a prescribed grain size, of carbon black and a colorant pigment. The invention further relates to a process for the production of the film and to the use of the film.

### BACKGROUND OF THE INVENTION

White or opaque, biaxially oriented polyester films, in particular for application as lid of pots used as packaging for foods, are known in the prior art.

EP 0 605 130 B1 (whose United States equivalent is U.S. Pat. No. 5,800,911) describes a multilayer, coextruded composite film with thickness in the range from 30 to 400 μm. The film comprises an opaque crystalline first polyester layer, in essence impermeable to visible light, the density of which is more than 1.30 g/cm³, the thickness of which is greater than or equal to 25 μm, and the deformation index of which is greater than or equal to 2.5%. The deformation index is measured at a temperature of 200° C. and under a pressure of 2 MPa. The film also comprises a transparent crystalline second polyester layer which is “substantially permeable to visible light” and which has a TOD (transmission optical density) of from 0.005 to 0.2. For the purposes of the invention, said layer is moreover transparent if the amount present therein of particles of size in the range from 0.1 to 10 μm is less than 2%.

EP 1 176 004 A1 describes a white, biaxially oriented polyester film with at least one base layer (B), the specific mechanical properties of which give it very good suitability as lid film, in particular as lid film for yogurt pots. A characterizing feature of the known film is that the R value is smaller than or equal to 45 dN/mm² and the eₘₐₓ ratio is smaller than or equal to 2.5. By virtue of compliance with said values, the film has less tendency toward delamination and exhibits good performance in peeling from the pot. The film further features good opacity, but has shortcomings in its production process (non-ideal presentation of the roll) and in its optical properties.

The use of phyllosilicates in biaxially oriented polyester films is known in the prior art.

EP 1 489 131 A1 (whose United States equivalent is United States Patent Application Publication No. 2004/0151900) describes the addition of Mica and aromatic polyester in monofilms. The diameter of the special-effect pigments here is from 0.5 to 1.25 μm, and the amount of these used was from 0.5 to 30% by weight, based on the total weight of the film. The optical properties of the film, e.g. reflection, make it useful in displays using liquid crystals.

Metallized, white polyester films are known from the prior art, in particular for yogurt-lid applications.

White-metallized films are used as lid film in packaging technology. An advantageous factor here in many applications, alongside the desired metallic-luster layer, is the optical density. However, low transparency of the lid is not always required or cost-effective. Nevertheless, the end consumer often associates the metallic-luster layer with the certainty that the food-or-drink product thereunder has particularly good protection from damaging environmental effects.

### SUMMARY OF ADVANTAGEOUS EMBODIMENTS OF THE INVENTION

It was therefore an object of the present invention to provide a white, biaxially oriented polyester film with metallic-luster outer layer in one process step without subsequent metallization, in particular for applications as lid film on pots used as packaging, where this features properties improved with respect to the metallized, white polyester films established in the market, and among these properties are in particular,
lower transparency than white lid films of the prior art;
secure adhesion of the metallic-luster layer on the polyester film;
microwave-suitability of the lid.

### BRIEF DESCRIPTION OF THE DRAWINGS

FIG. 1 is a graphic illustration of an exemplary cumulative particle size distribution curve and d₅₀.

### DETAILED DESCRIPTION OF ADVANTAGEOUS EMBODIMENTS OF THE INVENTION

The invention achieves the object via provision of a white, coextruded, biaxially oriented polyester film with a base layer (B) comprised of thermoplastic polyester and with at least one outer layer (A) comprised of thermoplastic polyester, where the characterizing features of the film are that
a) the base layer (B) comprises a concentration of from 3 to 15% by weight, based on the total weight of the base layer (B), of a whitening pigment, and
b) the outer layer (A) also comprises, alongside a concentration of from 3 to 15% by weight of a whitening pigment, a concentration of from 0.5 to 15% by weight of a coated colorant phyllosilicate and a concentration of from 0.001 to 0.2% by weight of carbon black, each concentration being based on the total weight of the outer layer (A).

The white, biaxially oriented film of the present invention has a structure of at least two layers. It is then comprised of the base layer (B) and of the outer layer (A) applied via coextrusion to one side of the same, where the two layers comprise at least one white pigment, and where the outer layer (A) also comprises a preferred concentration of from 0.5 to 15% by weight of a coated colorant phyllosilicate and an amount of from 0.001 to 0.2% by weight of carbon black.

The film of the invention has particularly advantageous effect in lid applications for pots used as packaging in the food and drink industry. Whereas metallized films cause problems in the microwave during the heating of ready meals, e.g. hot rice pudding, due to occurrence of corona discharges, the film of the invention can be used without problems in these applications.

In the preferred embodiment, the film has a structure of three layers, or indeed more than three layers, for example four or five layers.

In the preferred three-layer embodiment, the film is comprised of the base layer (B), of the outer layer (A), and of a further outer layer (C) arranged opposite to the outer layer (A). Particular preference is given here to the asymmetrical three-layer structure (ABC) in which the layer (C) is a modified layer based on the base layer (B). The outer layer (C) comprises, alongside the white pigment, an antiblocking agent which provides better winding of the film.

Surprisingly, the preferred use of, in essence, the rutile form of TiO₂ as whitening pigment has been found to make the film less susceptible to tearing and delamination. Addition of TiO₂, preferably by way of masterbatch technology, has the advantage of permitting easy correction of color differences, e.g. arising via inconsistent properties of regrind.

Addition of phyllosilicate and carbon black, preferably by way of masterbatch technology, has similarly proven particularly advantageous for producing the metallic-luster outer layer (A), which has the appearance of aluminum. Whereas direct addition of said two additives led to formation of agglomerates and consequently color differences on the metallic-luster side, masterbatch technology was capable of producing a layer with very good homogeneity.

Polymers used for the base layer (B) and for the outer layer (A):

### Base Layer (B)

The base layer (B) of the film is comprised of at least 80% by weight, preferably at least 85% by weight, and preferably at least 90% by weight, of a thermoplastic polyester. Polyesters suitable for this purpose are those comprised of ethylene glycol and terephthalic acid (=polyethylene terephthalate, PET), of ethylene glycol and naphthalene-2,6-dicarboxylic acid (=polyethylene 2,6-naphthalate, PEN), of 1,4-bishydroxymethylcyclohexane and terephthalic acid [=poly(1,4-cyclohexanedimethylene terephthalate, PCDT)], and also of ethylene glycol, naphthalene-2,6-dicarboxylic acid and biphenyl-4,4′-dicarboxylic acid (=polyethylene 2,6-naphthalate bibenzoate, PENBB). Particular preference is given to polyesters comprised of at least 90 mol %, in particular at least 95 mol %, of ethylene glycol units and terephthalic acid units or of ethylene glycol units and naphthalene-2,6-dicarboxylic acid units. The remaining monomer units are derived from other aliphatic, cycloaliphatic, or aromatic diols and/or other dicarboxylic acids. The base layer is preferably comprised of polyethylene terephthalate. Examples of other suitable aliphatic diols are diethylene glycol, triethylene glycol, aliphatic glycols of the formula HO—(CH₂)ₙ—OH, where n is an integer from 3 to 6 (in particular propane-1,3-diol, butane-1,4-diol, pentane-1,5-diol, and hexane-1,6-did), or branched aliphatic glycols having up to 6 carbon atoms. Among the cycloaliphatic diols, mention should be made of cyclohexanediols (in particular cyclohexane-1,4-diol). Examples of other suitable aromatic diols are those of the formula HO—C₆H₄—X—C₆H₄—OH where X is —CH₂—, —C(CH₃)₂—, —C(CF₃)₂—, —O—, —S— or —SO₂—. Other suitable bisphenols are those of the formula HO—C₆H₄—C₆H₄—OH.

Preferred other aromatic dicarboxylic acids are benzenedicarboxylic acids, naphthalenedicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid), or stilbene-x,x′-dicarboxylic acids. Among the cycloaliphatic dicarboxylic acids, mention may be made of cyclohexanedicarboxylic acids (in particular cyclohexane-1,4-dicarboxylic acid). Among the aliphatic dicarboxylic acids, particularly suitable compounds are the (C₃-C₁₉)alkanediacids, where the alkane moiety may be straight-chain or branched.

The polyesters can by way of example be prepared by the known transesterification process. In this, the starting materials are dicarboxylic esters and diols, these being reacted with the conventional transesterification catalysts, such as zinc salts, calcium salts, lithium salts, magnesium salts, and manganese salts. The intermediates are then polycondensed in the presence of well-known polycondensation catalysts, such as antimony trioxide or titanium salts. They can also equally well be prepared by the direct esterification process in the presence of polycondensation catalysts. Here, the dicarboxylic acids and the diols are used directly as starting materials.

### Outer Layer (A)

The polyesters used for the outer layer (A) and for any further intermediate layers (D) and (E) present are preferably the same as those stated above for the base layer (B). The whitening pigment is also incorporated, using masterbatch technology. The phyllosilicates used (mica) and the carbon (carbon black) are likewise preferably incorporated into the outer layer by using masterbatch technology.

### Whitening Pigment

The necessary whitening pigments are incorporated into the base layer (B) and into the outer layer (A), but also possibly into other layers present, in order to achieve the abovementioned properties, in particular the desired whiteness of the film. Examples of materials that can be used are titanium dioxide, calcium carbonate, barium sulphate, zinc sulphide, or zinc oxide. It is preferable to use TiO2 as sole whitening pigment. It is preferably added in the form of extrusion masterbatch to the original raw material. Typical ranges for the concentration of TiO2 in the extrusion masterbatch are from 20 to 70% by weight. The titanium dioxide can be either in rutile form or else in anatase form. It is preferable to use titanium dioxide in the rutile form. The grain size of the titanium dioxide is generally from 0.05 to 0.5 μm, preferably from 0.1 to 0.3 μm. The concentrations provided of the pigments thus incorporated give the film a brilliant white appearance.

### Phyllosilicate (Mica) and Carbon Black

The phyllosilicates (mica) have a chemical constitution corresponding to the following formula (source: Wikipedia, free encyclopedia):

I_{0,5-1}M₂₋₃[T₄O₁₀A₂]
I: Cations having a coordination number of 12 (potassium, sodium, calcium, barium, rubidium, cesium, ammonium)
M: Cations having a coordination number of 6 (lithium, magnesium, iron²⁺, manganese, zinc, aluminum, iron³⁺, chromium, vanadium, titanium)
T: Cations having a coordination number of 4 (silicon, aluminum, iron³⁺, boron, beryllium)
A: Anion (hydroxide, fluoride, chloride, oxide, sulphide).

Micas coated with rutile titanium dioxide have proven particularly advantageous for incorporation into the polyester. Concentrations of up to 50% by weight of these fillers, of silvery appearance, can be incorporated into the polyester. The further addition of carbon black can adjust the color tints appropriately, so that the very surprising result is the ability to imitate the color of aluminum foil. Particularly suitable coated micas which have led to these brilliant and entirely unexpected results are the titanium-dioxide- and tin-oxide-coated phyllosilicates from Merck, DE, obtainable commercially as IRIODIN® 111. Suitable carbon blacks have proven to be the industrial carbon blacks from Cabot, BLACK PEARLS® 4750 and BLACK PEARLS® 4350. The proportion of extractable constituents to ISO 6209 using toluene as solvent is preferably <0.1%. The iodine number of said carbon blacks is <300 mg/g, according to information from the producer. The size of the primary particles, likewise according to information from the producer, is <1 μm, preferably <0.5 μm, particularly preferably <0.2 μm.

In order to arrive at the desired whiteness, greater than 50, and at the desired low transparency, smaller than 10%, the base layer (B) should be a highly filled layer. The concentration of whitening pigment needed to achieve the desired low transparency is above 3% by weight but below 15% by weight, preferably above 3.5% by weight but below 14% by weight, and very particularly preferably above 4% by weight but below 13% by weight, based on the total weight of the layer comprising the same.

For a further increase in whiteness, suitable optical brighteners can be added to the base layer and/or to the layer (C). Examples of suitable optical brighteners are HOSTALUX® KS from Clariant or EASTOBRITE® OB-1 from Eastman.

The thickness of the outer layer (A) in the film of the invention is generally greater than 1.0 μm and smaller than 8.0 μm, preferably in the range from 1.5 to 7.0 μm, particularly preferably in the range from 2.0 to 6.0 μm.

The base layer (B), and also the further layers (A) and (C), can also comprise conventional additives, e.g. stabilizers. They are usually added to the polymer or polymer mixture prior to melting. Examples of stabilizers used are phosphorus compounds, such as phosphoric acid or phosphoric esters.

The total thickness of the polyester film of the present invention can vary widely. It is from 12 to 250 μm, preferably from 23 to 200 μm, with particular preference from 36 to 150 μm, the proportion made up by the base layer (B) here preferably being from 50 to 95% of the total thickness of the film.

### Production Process

The present invention also provides a process for the production of the films of the invention. It comprises the following steps:

Production of a multilayer film comprised of a base layer (B) and of at least one outer layer (A) coextrusion and shaping of the melts to give a flat melt film, and also, subsequently thereto,

production of a prefabricated film via cooling of the melt film on a take-off roll, longitudinal and transversal biaxial stretching of the prefilm, and heat-setting of the biaxially stretched film.

The polymer or the polymer mixture of the individual layers is first compressed and plasticized in an extruder. For the shaping of the melts to give a flat melt film, the melts are simultaneously extruded through a slot die, and the extruded multilayer film is drawn off on one or more take-off rolls, whereupon the melt cools and solidifies to give a prefilm.

The biaxial stretching process is generally carried out sequentially. In this process, the material is preferably stretched first longitudinally (i.e. in machine direction=MD) and then transversely (i.e. perpendicularly to machine direction=TD). The longitudinal stretching can be carried out with the aid of two rolls running at different speeds corresponding to the desired stretching ratio. An appropriate tenter frame is generally used for the transverse stretching process.

The temperature at which polyester can generally be biaxially oriented can vary relatively widely, and dependent on the desired properties of the film. The longitudinal stretching process is generally carried out at from about 80 to 140° C., and the transverse stretching process is generally carried out at from about 80 to 150° C. The longitudinal stretching ratio (lambda MD) here is in the range 2.0:1 to 5:1. The transverse stretching ratio (lambda TD) is generally in the range from 2.5:1 to 5.0:1. Prior to the transverse stretching process, one or both surfaces of the film can be in-line-coated by the known processes. By way of example, the in-line coating can serve to improve adhesion of any printing ink subsequently applied, or else can serve to improve antistatic performance or processing performance.

During the heat-setting process that follows, the film is kept at a temperature of from about 150 to 250° C. for a period of from about 0.1 to 10 s. The film is then cooled and conventionally wound.

After the biaxial stretching process, it is preferable that one or both surfaces of the film are also corona- or flame-treated by one of the known methods. The intensity of treatment is generally above 50 mN/m.

The film of the invention is suitable as packaging material for food and other consumable items, in particular as a lid film for food-or-drink containers, e.g. yogurt pots. The film also has excellent suitability for the packaging of foods and other consumable items, where these are likewise packaged in pots of this type and are sensitive to moisture and/or sensitive to air.

The film of the present invention also has excellent optical properties, and exhibits excellent further-processing properties and exceptional

TABLE 1

| | | | | |
|---|---|---|---|---|
| | | Very | | |
| | Particularly | particularly | | |
| Preferred | preferred | preferred | Unit | Test method |

Base layer (B)

| | | | | | |
|---|---|---|---|---|---|
| Concentration of whitening | 3.0 to 15.0 | 3.5 to 14.0 | 4.0 to 13.0 | % | Internal |
| filler | | | | | |

Outer layer (A)

| | | | | | |
|---|---|---|---|---|---|
| Concentration of whitening filler | 3.0 to 15.0 | 3.5 to 14.0 | 4.0 to 13.0 | % | Internal |
| Concentration of phyllosilicate | 0.5 to 15.0 | 1.0 to 14.0 | 1.5 to 13.0 | % | Internal |
| filler (mica) | | | | | |
| d₅₀ particle diameter of | 0.5 to 20.0 | 1.0 to 17.5 | 1.5 to 15.0 | μm | See |
| phyllosilicate (mica) | | | | | description |
| Concentration of carbon black | 0.001 to 0.2 | 0.005 to 0.15 | 0.01 to 0.10 | % | Internal |
| filler | | | | | |
| Outer layer thickness | 1 to 8 | 1.5 to 7.0 | 2.0 to 6.0 | μm | Internal |
| Gloss (60°) | <45 | <40 | <35 | | DIN 67530 |

Film properties

| | | | | | |
|---|---|---|---|---|---|
| Thickness of film | 12 to 250 | 23 to 200 | 36 to 150 | μm | Internal |
| Whiteness of film | >50 | >53 | >56 | | See |
| (outer layer (A)) | | | | | description |
| Transparency of film | <10 | <8 | <6 | % | ASTM 1033-77 |
| Yellowness index of film | <100 | <90 | <80 | | ATM 1925-70 |

The following test methods were used in the present application to characterize the raw materials and the films:
DIN=Deutsches Institut für Normung [German Institute for Standardization]
ASTM=American Society for Testing and Materials

### Transparency

Transparency is measured by a method based on ASTM D1033-77.

### Yellowness Index

The yellowness index of the film is determined to ASTM D1925-70 by means of a LAMBDA® 12 spectrophotometer from Perkin Elmer (USA), D65 standard illuminant, 10° standard observer. Yellowness index YI is calculated from the standard color coordinates X, Y, Z by using the following equation

YI=[100·(1.28·X−1.06Z)]/Y

### Whiteness

Whiteness is determined by the Berger method, generally by mutually superposing more than 20 layers of film. Whiteness is determined with the aid of an ELREPHO® electrical reflectance photometer from Zeiss, Oberkochem (DE), standard illuminant C, 2° standard observer. Whiteness WG is defined as

WG=RY+3RZ−3RX,

where RX, RY, RZ are corresponding reflectance factors using an X, Y or Z color-measurement filter. The white standard used comprises a barium sulfate pressing (DIN 5033, part 9). A detailed description is provided by way of example in Hans Loos, Farbmessung [Color measurement], Verlag Beruf und Schule, Itzehoe (1989).

### SV (Standard Viscosity)

Standard viscosity SV (DCA) is measured at 25° C. in dichloroacetic acid by a method based on DIN 53726. Intrinsic viscosity (IV) is calculated from standard viscosity as follows:

IV(DCA)=6.907·10⁻⁴SV(DCA)+0.063096 [dl/g]

### Gloss

Gloss is determined to DIN 67 530. Reflectance is measured, this being an optical value characteristic of a film surface. Using a method based on the standards ASTM D523-78 and ISO 2813, the angle of incidence is set at 60°. A beam of light hits the flat test surface at the set angle of incidence and is reflected or scattered by the surface. A proportional electrical variable is displayed, representing light rays hitting the photoelectronic detector. The value measured is dimensionless.

Measurement of Median Diameter d₅₀

Median diameter d₅₀ is determined by means of a laser on a Malvern Mastersizer, using the standard method (examples of other measurement equipment being Horiba LA® 500 or Sympathec HELOS®, which use the same measurement principle). For the test, the specimens are placed with water in a cell and this is then placed in the measurement equipment. The measurement procedure is automatic and also includes the mathematical determination of d₅₀.

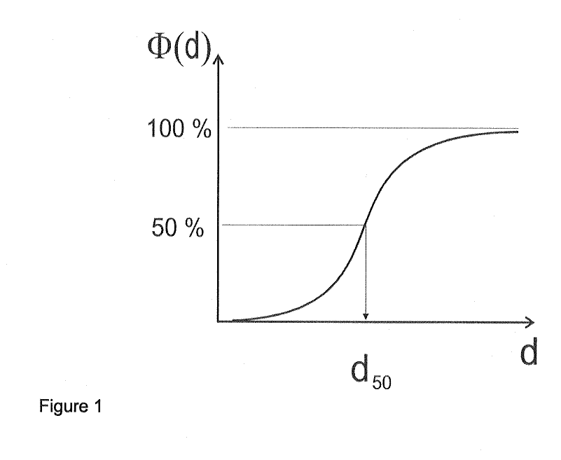

d₅₀ here is defined as determined as follows from the (relative) cumulative particle size distribution curve: the desired d₅₀ is directly given on the abscissa axis by the intersection of the 50% ordinate value with the cumulative curve. FIG. 1 illustrates in more detail what is meant by this.

### Measurement of Contact Angle

Contact angle is measured by DAS-100 equipment from Krüss GmbH, Germany.

### Example 1

Chips comprised of polyethylene terephthalate comprising the rutile form of titanium dioxide as white pigment were dried at a temperature of 155° C. for a period of 2 hr and introduced into the extruder for the base layer (B). In parallel with this, chips comprised of polyethylene terephthalate comprising the rutile form of titanium dioxide as whitening pigment and chips comprising coated mica and carbon black were dried under the same conditions and introduced into the extruder for the outer layer (A). Further chips for the outer layer (C) comprising a titanium dioxide and an antiblocking agent to improve windability were likewise dried and introduced to the extruder for the outer layer (C).

Coextrusion followed by a stepwise longitudinal and transverse orientation was then used to produce a white, three-layer film with ABC structure and with a total thickness of 50 μm. The thickness of the outer layers (A) and (C) was in each case 5 μm.

Outer layer (A) was a mixture comprised of:

| | |
|---|---|
| 56% by weight | of polyethylene terephthalate with SV |
| | value 800, |
| 14% by weight | of masterbatch from Sukano |
| | (Schindellegi, CH) with 50% by weight |
| | of titanium dioxide (average particle |
| | diameter of titanium dioxide about |
| | 0.3 μm), and |
| 30% by weight | of masterbatch comprised of 69.99% by |
| | weight of polyethylene terephthalate |
| | (SV value 800) and 30% by weight of |
| | IRIODIN ® 111 (titanium-dioxide- and |
| | tin-oxide-coated phyllosilicate from |
| | Merck, DE, d₅₀ value - 12 μm) and |
| | 0.01% of BLACK PEARLS ® 4750 carbon |
| | black from Cabot. |

Base layer (B) was a mixture comprised of:

| | |
|---|---|
| 86% by weight | of polyethylene terephthalate with SV |
| | value 800 and |
| 14% by weight | of masterbatch from Sukano |
| | (Schindellegi, CH) with 50% by weight |
| | of titanium dioxide (average particle |
| | diameter of titanium dioxide about |
| | 0.3 μm), and |

Outer layer (C) was a mixture comprised of:

| | |
|---|---|
| 70% by weight | of polyethylene terephthalate with SV |
| | value 800, |
| 14% by weight | of masterbatch from Sukano |
| | (Schindellegi, CH) with 50% by weight |
| | of titanium dioxide (average particle |
| | diameter of titanium dioxide about |
| | 0.3 μm), and |
| 16% by weight | of masterbatch comprised of 97.5% by |
| | weight of polyethylene terephthalate |
| | (SV value 800) and 2.5% by weight of |
| | SYLOBLOC ® 44 H (synthetic SiO₂ from |
| | Grace, average diameter = 2.5 μm) |

The production conditions in the individual steps for the process were:

| Extrusion | Temperatures | Layer A: | 280° | C. |
|---|---|---|---|---|
| | | Layer B: | 280° | C. |
| | | Layer C: | 280° | C. |
| | Take-off roll temperature | | 20° | C. |
| Longitudinal | Heating temperature | | 70-90° | C. |
| stretching | Stretching temperature | | 85° | C. |
| | Longitudinal stretching ratio | | 3.2 | |
| Transverse | Heating temperature | | 100° | C. |
| stretching | Stretching temperature | | 115° | C. |
| | Transverse stretching ratio | | 3.8 | |
| Setting | Temperature | | 230° | C. |
| | Period | | 3 | s |

A film was obtained with very good optical properties (transparency, yellowness index, whiteness) and with very good processing performance. The film exhibited the desired metallic appearance on side A.

### Example 2

In comparison with example 1, it was only the constitution of the outer layer (A) that was now changed. After the longitudinal stretching process and prior to the transverse stretching process, the film was also coated in-line with an acrylate copolymer on the outer layer (C). An acrylate copolymer coating was used here which has been described in example 1 in EP 0 144 948 B2 (whose United States equivalent is U.S. Pat. No. 4,571,363). The dry weight of the coating was 0.035 g/m², with a dry coating thickness of 0.03 μm. The contact angle with water was 72.9° on the outer layer (C).

All of the other parameters were retained as in example 1.

Outer layer (A) was a mixture comprised of:

| | |
|---|---|
| 36% by weight | of polyethylene terephthalate with SV |
| | value 800, |
| 14% by weight | of masterbatch from Sukano |
| | (Schindellegi, CH) with 50% by weight |
| | of titanium dioxide (average particle |
| | diameter of titanium dioxide about |
| | 0.3 μm), and |
| 50% by weight | of masterbatch comprised of 69.99% by |
| | weight of polyethylene terephthalate |
| | (SV value 800) and 30% by weight of |
| | IRIODIN ® 111 Rutile Fine Satin |
| | (titanium-dioxide- and tin-oxide- |
| | coated mica from Merck, DE, d₅₀ value = |
| | 12 μm) and 0.01% of BLACK PEARLS ® |
| | 4750 carbon black from Cabot. |

A film was obtained with very good optical properties (transparency, yellowness index, whiteness) and with very good processing performance. The film of the invention has a metallic-luster layer. There is no requirement for metallizing in order to obtain the appearance, which is effective for promotional purposes. Because of the presence of the acrylic adhesion promoter on the free surface of the outer layer (C), the film can be printed with conventional printing inks.

### Comparative Example 1

Inventive example 1 was modified and the material was run in the form of the following ABA structure:

### Base Layer (B):

| | |
|---|---|
| 86% by weight | of polyethylene terephthalate with SV |
| | value 800, and |
| 14% by weight | of masterbatch from Sukano |
| | (Schindellegi, CH) with 50% by weight |
| | of titanium dioxide (average particle |
| | diameter of titanium dioxide about |
| | 0.3 μm). |

Outer layer (A) and outer layer (C) were a mixture comprised of:

| | |
|---|---|
| 70% by weight | of polyethylene terephthalate with SV |
| | value 800, |
| 14% by weight | of masterbatch from Sukano |
| | (Schindellegi, CH) with 50% by weight |
| | of titanium dioxide (average particle |
| | diameter of titanium dioxide about |
| | 0.3 μm), and |
| 16% by weight | of masterbatch comprised of 97.5% by |
| | weight of polyethylene terephthalate |
| | (SV value 800) and 2.5% by weight of |
| | SYLOBLOC ® 44 H (synthetic SiO₂ from |
| | Grace, diameter = 2.5 μm). |

All of the other parameters of inventive example 1 were retained. The film did not comply with the required optical properties (transparency, gloss). The metallic-luster layer, effective for promotional purposes, was absent. A further operation, e.g. metallization, would be required for subsequent application of said metallic-luster layer.

### Comparative Example 2

The film from comparative example 1 was metallized with aluminum in a further operation. The film complied with all of the optical properties, but was not suitable as lid film for microwave applications.

Table 2 below collates the results of the inventive examples and of the comparative examples:

TABLE 2

| | | Whiteness, measured from | | Yellow- | Gloss (60°) | | Metallic- | Film suitable |
|---|---|---|---|---|---|---|---|---|
| | Trans- | Outer layer | Outer layer | ness | Outer | Outer | luster outer | for microwave |
| | parency % | (A) | (C) | index | layer (A) | layer (C) | layer (A) | oven |
| Inv. ex. 1 | 3.4 | 62 | 84 | 69 | 34 | 88 | Yes | Yes |
| Inv. ex. 2 | 1.8 | 58 | 80 | 57 | 25 | 87 | Yes | Yes |
| Comp. Ex. 1 | 28 | 95 | 94 | 38 | 89 | 88 | No | Yes |
| Comp. Ex. 2 | 0.01^{A} | 95^{B} | 94^{B} | 38^{B} | 89^{B} | 88^{B} | Yes | No |

For comparative example 2:
^{A}= measured after metallization
^{B}= measured prior to metallization
Comp. ex. = comparative example

That which is claimed is:

1. A white, coextruded, biaxially oriented polyester film with a base layer (B) comprised of thermoplastic polyester and at least one outer layer (A) comprised of thermoplastic polyester, wherein
a) the base layer (B) comprises, based on the total weight of the base layer (B), a concentration of from 3 to 15% by weight of a whitening pigment, and
b) the outer layer (A) also comprises, based in each case on the total weight of the outer layer (A), a concentration of from 3 to 15% by weight of a whitening pigment, a concentration of from 0.5 to 15% by weight of a coated colorant phyllosilicate, and a concentration of from 0.001 to 0.2% by weight of carbon black.

2. The polyester film as claimed in claim 1, wherein said film has a three-layer structure and further comprises, alongside the base layer (B) and the outer layer (A), a further outer layer (C) which is comprised of thermoplastic polyester and arranged opposite the outer layer (A), said outer layer (C) also comprising an antiblocking agent, alongside a colorant pigment.

3. The polyester film as claimed in claim 1, wherein said thermoplastic polyesters comprise polycondensates comprised of ethylene glycol and terephthalic acid, comprised of ethylene glycol and naphthalene-2,6-dicarboxylic acid, comprised of 1,4-bishydroxymethylcyclohexane and terephthalic acid, or comprised of ethylene glycol, naphthalene-2,6-dicarboxylic acid, and biphenyl-4,4′-dicarboxylic acid.

4. The polyester film as claimed in claim 1, wherein said whitening pigments comprise titanium dioxide, calcium carbonate, barium sulfate, zinc sulfide or zinc oxide.

5. The polyester film as claimed in claim 4, wherein said titanium dioxide is of rutile type or of anatase type, added in the form of an extrusion masterbatch to the original raw material.

6. The polyester film as claimed in claim 1, wherein said whitening pigment is titanium dioxide of rutile type and has an average grain size in the range from 0.05 to 0.5 μm.

7. The polyester film according to claim 1, wherein said phyllosilicate comprises an inorganic compound with a chemical constitution corresponding to the following general formula:
I_{0,5-1}M₂₋₃[T₄O₁₀A₂]
Where:
I is a cation having a coordination number of 12,
M is a cation having a coordination number of 6,
T is a cation having a coordination number of 4, and
A is an anion,
with an inorganic coating.

8. The polyester film as claimed in claim 1, wherein said phyllosilicate comprises mica coated with rutile titanium dioxide.

9. The polyester film as claimed in claim 1, wherein said phyllosilicate comprises mica coated with titanium dioxide and tin oxide.

10. The polyester film as claimed in claim 1, wherein the whiteness of said film is greater than 50 and the transparency of said film is smaller than 10%, said film comprising, based on the total weight of the layer comprising the whitening pigment, a concentration in the range from 4 to 13% by weight of whitening pigment.

11. The polyester film as claimed in claim 1, wherein said film has a total thickness in the range from 12 to 250 μm and the proportion of the total film thickness made up by the base layer (B) is from 50 to 95%.

12. A process for producing a polyester film as claimed in claim 1, said process comprising
coextruding and shaping polymer melts to give a flat melt film,
producing a pre-film via cooling of the flat melt film on one or more take-off rolls,
biaxially stretching said pre-film in the longitudinal and transverse direction, and
heat-setting the biaxially stretched film.

13. The process as claimed in claim 12, wherein the biaxial stretching process is carried out sequentially by stretching first longitudinally and then transversely, and by setting a longitudinal stretching ratio in the range from 2.0:1 to 5:1 and by setting a transverse stretching ratio in the range from 2.5:1 to 5.0:1.

14. The process as claimed in claim 12, wherein, prior to the transverse stretching process, one or both surfaces of the film are in-line-coated.

15. The process as claimed in claim 12, wherein, the heat-setting step comprises keeping the film at a temperature of about 150 to 250° C. for a period of from 0.1 to 10 s.

16. The process as claimed in claim 12, wherein, after the biaxial stretching process, one or both surfaces of the film is/are corona- or flame-treated, the intensity of this treatment being above 50 mN/m.

17. The process as claimed in claim 12, wherein said process further comprises returning to the extrusion process an amount of from 20 to 60% by weight, based on the total weight of the film, of regrind formed from cut material produced during film production.

18. Packaging material for foods and other consumable items comprising polyester film as claimed in claim 1.

19. Packaging material for foods and other consumable items as claimed in claim 18, wherein said food or other consumable items are sensitive to moisture and/or sensitive to air.

20. Packaging material for foods and other consumable items as claimed in claim 18, wherein said films are processed on high-speed packaging machinery.

21. The polyester film as claimed in claim 6, wherein said whitening pigment is titanium dioxide of rutile type having an average grain size of from 0.1 to 0.3 μm.

22. The polyester film as claimed in claim 7, wherein
I is potassium, sodium, calcium, barium, rubidium cesium, or ammonium,
M is lithium, magnesium, iron²⁺, manganese, zinc, aluminum, iron³⁺, chromium, vanadium, or titanium,
T is silicon, aluminum, iron³⁺, boron, or beryllium, and
A is a hydroxide, fluoride, chloride, oxide, or sulfide.

23. The polyester film as claimed in claim 11, wherein the total thickness of said film is in the range from 23 to 200 μm.

24. The polyester film as claimed in claim 11, wherein the total thickness of said film is in the range from 36 to 150 μm.

25. Packaging material for foods and other consumable items as claimed in claim 18, wherein said packaging material comprises lidding film for pots suitable for the packaging of food or drink.
